(19) United States
(12) Patent Application Publication
(10) Pub. No.: US 2016/0007700 A1
(43) Pub. Date: Jan. 14, 2016

(54) ELEMENT FORMING A DECORATIVE PART COMPRISING A RUBBER RECEIVING ELEMENT

(71) Applicant: LA TÊTE DANS LES ETOILES SA, Carouge (CH)

(72) Inventor: Pascal-Vincent VAUCHER, Carouge (CH)

(21) Appl. No.: 14/771,977

(22) PCT Filed: Mar. 4, 2014
(86) PCT No.: PCT/IB2014/000240

§ 371 Date: Sep. 1, 2015

(30) Foreign Application Priority Data
Mar. 4, 2013 (CH) 00537/13

(51) Int. Cl. A44C 17/02; H04M 1/02; B60R 13/00; A44C 27/00; G04B 47/04

(52) U.S. Cl. CPC A44C 17/02; A44C 27/001; A44C 27/002; G04B 47/042; B60R 13/00; H04M 1/0202

(57) ABSTRACT

A constituent element of a decorative item comprises at least one hollow recess (3) in a flexible material (2) arranged on a rigid structure (1), the upper ends of the recess or recesses (3) having a bearing surface (40) by means of which it is possible, by compression of said flexible material (2) on said rigid structure (1), to set in said recess (3) an added part (5) whose periphery made of hard material has a shape and dimensions which correspond to those of said recess (3) and which has a projecting portion (6) which compresses said flexible material (2) on said rigid structure (1) when said added part (5) is introduced into said recess (3) such that said added part (5) is secured in said recess (3).

The present invention relates to a constituent element of a decorative item comprising a recess made of a flexible material such as rubber.

Already known from the prior art are adornment items, such as watches for example, using rubber in conjunction with metal in particular. The metal lends the assembly rigidity, while the rubber gives a particular esthetic quality.

EP1350438 describes an adornment item by means of which it is possible to arrange diamonds such that they are surrounded with rubber, while ensuring that they are securely fixed. It relates in particular to an adornment item of the type comprising a base structure made of metal and a covering layer arranged on the base structure, on part of its surface. The covering layer forms a cut-out designed to receive a stone, and the base structure is provided with columns, forming grains designed for setting the stone, which extend into the cut-out, close to the covering layer. The grains are uncovered over a portion at least of their height. They extend over the entire height of the covering layer, such that they can be deformed for the purpose of setting the stone. Of course, the stones cannot abut against one another. Thus, in order to provide unity to the assembly, the cut-out comprises a flat portion, provided with a coating of a material having a similar aspect and color to the covering layer. Contrary to the present invention, this type of setting requires grains to hold the stone.

One watchmaker has combined, for a wristwatch, a metal set with diamonds provided with a strap made of rubber. Since the diamonds cannot be set directly onto the rubber, they are attached to the metal, by setting, and the desired esthetic effect is diminished by the distance between the diamonds and the strap. The present invention addresses this drawback by setting the diamond directly onto the rubber.

The object of the present invention is to set added parts onto a flexible material for example rubber without using inserts to create in particular timepieces or jewelry items having a strong esthetic effect.

In accordance with the invention, a constituent element of a decorative item for example a timepiece or jewelry item comprises at least one hollow recess in a flexible material arranged on a rigid structure, the upper ends of the recess or recesses having a bearing surface by means of which it is possible, by compression of said flexible material on said rigid structure, to set in said recess an added part whose periphery made of hard material has a shape and dimensions which correspond to those of said recess and which has a projecting portion which compresses said flexible material on said rigid structure when said added part is introduced into said recess such that said added part is secured in said recess.

As flexible material, rubber is a material which has numerous advantages, in particular it has good abrasion resistance, it has remarkable tactile qualities and it is easily worked. Rubber may be natural or synthetic and may have various colorations.

The features of the invention will become clearer upon reading several embodiments, which are provided solely by way of example and are in no way limiting, with reference to the schematic figures, in which:

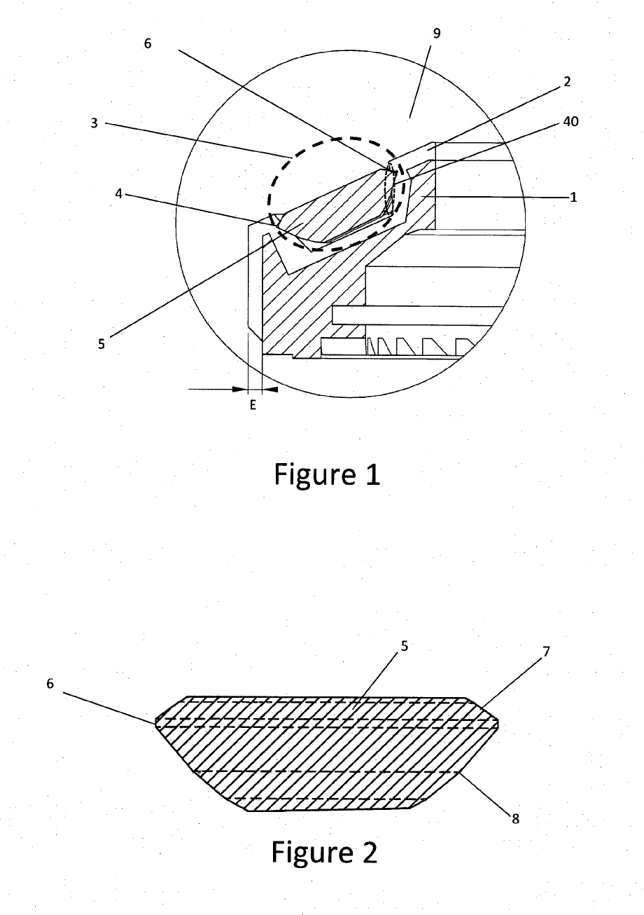

FIG. 1 shows a partial cross section of a watch bezel, according to the present invention, provided with a stone;

FIG. 2 shows a cross section of a stone cut to be added in a recess according to the present invention;

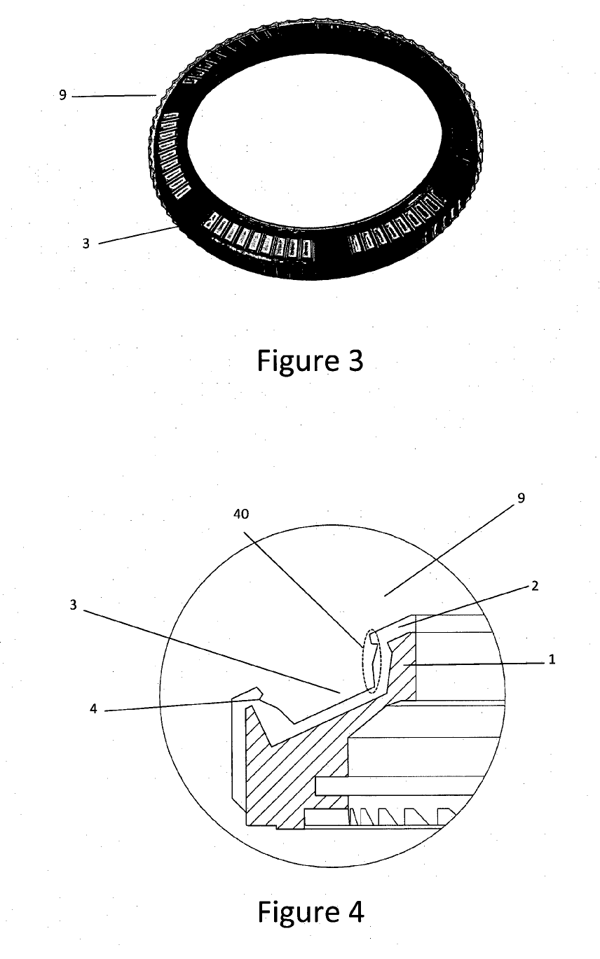

FIG. 3 shows a perspective view of a watch bezel according to the present invention;

FIG. 4 shows a partial cross section of a watch bezel, according to the present invention, without a stone;

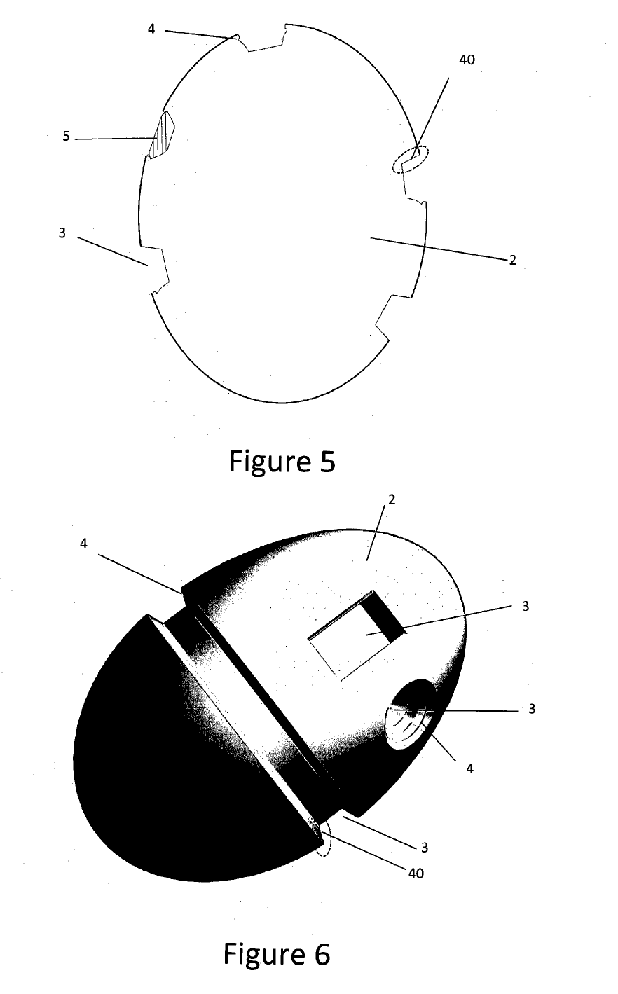

FIG. 5 shows a partial cross section of an oval-shaped decorative object according to the present invention; and

FIG. 6 shows a perspective view of an oval-shaped decorative object having multiple recesses according to the present invention.

According to the preferred form of the invention, a timepiece comprises a watch bezel 9 having hollow recesses 3 in a flexible material 2 made of rubber on a rigid structure 1, the upper ends of the recess or recesses 3 having a bearing surface 40 by means of which it is possible, by compression of said flexible material 2 made of rubber on said rigid structure 1, to set in said recess 3 an added part 5, for example a precious stone, whose periphery made of hard material has a shape and dimensions which correspond to those of said recess 3 and which has a projecting portion 6 which compresses said flexible material 2 made of rubber, on said rigid structure 1, when the precious stone 5 is introduced into said recess 3 such that the precious stone 5 is secured in said recess 3.

As shown in FIG. 1, a rigid structure 1 of a watch bezel 9 is arranged beneath the flexible material 2. The rigid structure 1 of the watch bezel 9 may, for example, be made of metal, the coating made of flexible material 2 then being an overmolding, of a thickness for example between 0.25 mm and 0.5 mm, which overmolding covers essentially all of the outer upper surface of the rigid structure 1 of the watch bezel 9.

The added part 5 compresses the rubber coating 2 against said rigid structure 1 when the added part 5 is introduced into each recess 3 such that the added part 5 is fixed solidly in each recess 3.

As shown in FIG. 2, the added part 5 may be a faceted element such as a precious stone, in which the projecting portion 6 consisting of the girdle, between the pavilion 8 and the crown 7, compresses the rubber coating 2 against said rigid structure when the added part 5 is introduced into each recess 3.

In another embodiment, the added part 5 may be made of ceramic, or another material which can be worked so as to have a projecting portion 6.

Irrespective of the shape of the added part 5, round, oval, trapezoidal, rectangular or other, it is the pressure of the projecting portion 6 on the bearing surface 40 of each recess 3 which holds the added part 5 in the recess 3.

The flexible rubber coating 2 must be stiff enough to be able to receive and hold an added part such as for example a precious stone 5, but the flexible rubber coating 2 must not be too hard so as to avoid damaging the added stone 5. The added part 5 being set, too hard a coating 2 would give rise to too great a force to add the part 5 in the recess 3, which would entail damage to the added part 5.

The flexible rubber coating 2 or other elastomer may be used with or, in one variant, without a rigid structure 1 for holding the added part 5.

The recess or recesses 3 made of flexible material 2 may, for example, be obtained by means of an overmolding or shaping process.

When the flexible material 2 takes the form of a rubber coating, the uncompressed thickness of the flexible material 2 is at least 0.25 mm.

As shown in FIG. 3, once the flexible coating 2 has been arranged on the rigid structure 1 of the watch bezel 9, it is no longer possible to distinguish the metallic structure 1, which rigid structure 1 may be optional in one variant. In this example, six elongate blocks, each comprising nine recesses 3 arranged side-by-side, can each receive nine added parts 5, this with the recesses 3 arranged in an arc of a circle.

In one variant, the recess 3 is elongate, by means of which it is possible to receive multiple added parts 5 arranged side-by-side in said recess 3.

As shown in FIGS. 1 and 4, the bearing surface 40 of the recess 3 comprises optionally at least one indentation 4 which engages with the projecting portion 6 of the added part 5. This indentation 4 can provide an additional hold for the added part 5 once it is set. The indentation 4 may be peripheral.

FIG. 5 shows a variant of a decorative object comprising an ovoid body which is either a solid body made of a flexible material 2 of the rubber type, or a core or rigid structure 1 coated with a flexible material 2 of the rubber type. In this body, there have been created a number of recesses 3 spaced over all or part of the surface of the decorative object. These recesses 3 receive added parts 5 set as described above. Seen from above, said recesses 3 are polygonal, that is to say that they may be in particular a rectangle, a square, a triangle, a parallelogram, a trapezium or a rhombus. In one variant, said recesses 3 may have a rounded shape, such as for example a circle or an ellipse.

As shown in FIG. 6, another ovoid decorative object has a round recess 3, a rectangular recess 3 and finally an annular channel or groove provided with an indentation 4 and in which a plurality of added parts 5, not shown, once set, will abut against one another. This ovoid decorative object may have a core or a rigid structure 1, for example made of metal, coated with a flexible material 2 of the rubber type or may consist of a single elastomer material, the central portion having a hardness which is sufficient to constitute a rigid framework which will make it possible to use the same elastomer material, having a different hardness and providing the possibility of setting added parts 5 without damaging said added part 5 or said softer elastomer material.

In one variant of FIG. 6, the recess 3 in the form of an annular channel may be divided into a number of recesses 3, each for an added part 5 (see FIG. 3). In the case of an annular channel, the two projecting portions 6 of each added part 5 make it possible to hold said added part 5 in the annular channel. In the case of individual recesses 3 (see FIG. 3) the added parts 5 may be held in the recess 3 by means of their periphery.

Another inventive aspect consists of a decorative item, comprising at least one hollow recess 3 in a flexible material 2, the upper ends of the recess or recesses 3 having a bearing surface 40 by means of which it is possible, by compression of said flexible material 2, to set in said recess 3 an added part 5, and comprising a plurality of added parts 5 arranged side-by-side and set in said recess 3 or in a plurality of recesses 3 arranged side-by-side.

According to this other inventive aspect, each recess 3 may be elongate, straight or curved or may comprise a plurality of recesses 3 arranged according to an elongate, straight or curved arrangement. It is equally possible to have a number of rectangular or arcuate recesses 3, adjoining one another, forming together a continuity of added parts 5. Moreover, FIG. 3 may equally illustrate either a plurality of added parts 5 in six arcuate recesses 3 or six elongate blocks each comprising nine recesses 3 arranged side-by-side, making it possible to each receive nine added parts 5, this with the recesses 3 arranged in an arc of a circle. According to this embodiment, the recesses 3 are elongate and curved and arranged according to an annular arrangement.

According to this other inventive aspect, the flexible material 2 is made of rubber or another elastomer.

According to this inventive aspect, each added part 5 is a stone whose projecting portion 6 consists of the portion known as the girdle 6, between the pavilion 8 and the crown 7.

According to this other inventive aspect, the flexible material 2 is in the form of a coating whose uncompressed thickness is at least 0.25 mm.

Still according to this other inventive aspect, the bearing surface 40 of each recess 3 comprises at least one indentation 4 which receives the projecting portion 6 of each added part 5. Optionally, the indentation 4 is peripheral.

In one variant of this other inventive aspect, a decorative item comprises at least one hollow recess 3 in a flexible material 2 arranged on a rigid structure 1, the upper ends of the recess or recesses 3 having a bearing surface 40 by means of which it is possible, by compression of said flexible material 2 on said rigid structure 1, to set in said recess 3 a plurality of added parts 5 arranged side-by-side in said recess 3 or in a plurality of recesses 3 arranged side-by-side.

According to this variant of this other inventive aspect, said rigid structure 1 is made of metal. Optionally, said rigid structure 1 is made of the same material as said flexible material 2, the hardness of said rigid structure 1 being greater than the hardness of said flexible material 2.

According to this other inventive aspect, the coating made of flexible material 2 is an overmolding, of a thickness between 0.25 mm and 0.5 mm, which overmolding covers essentially all of the outer upper surface of the rigid structure 1.

In the example shown in FIG. 6 and according to this other inventive aspect, a decorative object made of a flexible material 2, of ovoid shape, comprises an annular groove 3 provided with an indentation 4, the upper ends of the annular groove 3 having a bearing surface 40 by means of which it is possible, by compression of said flexible material 2, to set in said recess 3 a plurality of added parts 5 arranged side-by-side in said groove 3.

Still according to this other inventive aspect, a decorative item could comprise for example two juxtaposed recesses 3, in which the plurality of added parts 5 arranged side-by-side in each recess 3 would provide continuity or a row of added parts 5.

According to this other inventive aspect, the recess 3 comprising the plurality of added parts 5 may for example be elongate, straight or curved. For example, the rectangular recess shown in FIG. 6 could comprise multiple added parts 5 side-by-side.

According to this other inventive aspect, the flexible rubber coating 2 or other elastomer may be used with or, in one variant, without a rigid structure 1 for holding the added part 5.

The coating 2 may adopt various colorations, making it possible to play with the timepiece esthetic. One might for example imagine a wristwatch whose dial is black, the bezel according to the present invention is black and the stones, being emeralds, would light up the timepiece by virtue of their contrast.

In addition to a watch, the present invention can be applied to objects such as a ring, a necklace or a bracelet, for example.

It is conceivable to use the present invention in other fields, such as for example telephony, for decorating mobile phones, or accessories such as phone covers or pouches, or automobile accessories such as for example a gear stick, a steering wheel or a dashboard portion, or indeed other fields which provide ever more personalization for each client.

1. A constituent element of a decorative item, comprising at least one hollow recess (3) in a flexible material (2) arranged on a rigid structure (1), the upper ends of the recess or recesses (3) having a bearing surface (40) by means of which it is possible, by compression of said flexible material (2) on said rigid structure (1), to set in said recess (3) an added part (5) whose periphery made of hard material has a shape and dimensions which correspond to those of said recess (3) and which has a projecting portion (6) which compresses said flexible material (2) on said rigid structure (1) when said added part (5) is introduced into said recess (3) such that said added part (5) is secured in said recess (3).

2. The constituent element of a decorative item, as claimed in claim 1, in which the flexible material (2) is made of rubber.

3. The constituent element of a decorative item, as claimed in claim 1, in which the added part (5) is a stone whose projecting portion (6) consists of the portion known as the girdle (6), between the pavilion (8) and the crown (7).

4. The constituent element of a decorative item, as claimed in claim 1, according to which the flexible material (2) is in the form of a coating whose uncompressed thickness is at least 0.25 mm.

5. The constituent element of a decorative item, as claimed in claim 1, in which said rigid structure (1) is made of metal.

6. The constituent element of a decorative item, as claimed in claim 1, in which said rigid structure (1) is made of the same material as said flexible material (2), the hardness of said rigid structure (1) being greater than the hardness of said flexible material (2).

7. The constituent element of a decorative item, as claimed in claim 1, in which the coating made of flexible material (2) is an overmolding, of a thickness between 0.25 mm and 0.5 mm, which overmolding covers essentially all of the outer upper surface of the rigid structure (1).

8. The constituent element of a decorative item, as claimed in claim 1 in which said bearing surface (40) of the recess (3) comprises at least one indentation (4) which receives the projecting portion (6) of the added part (5).

9. The constituent element of a decorative item, as claimed in claim 8, in which the indentation (4) is peripheral.

10. The constituent element of a decorative item, as claimed in claim 1, comprising at least one hollow recess (3) in a flexible material (2), the recess or recesses (3) having a bearing surface (40) by means of which it is possible, by compression of said flexible material (2), to set in said recess (3) a plurality of added parts (5) arranged side-by-side in said recess (3) or in a plurality of recesses (3) arranged side-by-side.

11. The constituent element of a decorative item as claimed in claim 10, in which the recess (3) is elongate, straight or curved.

12. A timepiece in the form of a wristwatch, comprising an element as claimed in claim 1.

13. Jewelry item comprising an element as claimed in claim 1.

14. Portable element such as a mobile phone or mobile phone accessory, comprising an element as claimed in claim 1.

15. Automobile accessory or constituent element of an automobile comprising an element as claimed in claim 1.
